(19) United States
(12) Patent Application Publication
(10) Pub. No.: US 2025/0305252 A1
(43) Pub. Date: Oct. 2, 2025

(54) MOBILE BODY CONTROL DEVICE, MOBILE BODY CONTROL METHOD, AND STORAGE MEDIUM

(71) Applicant: HONDA MOTOR CO., LTD., Tokyo (JP)

(72) Inventor: Hisahiro Kato, Tokyo (JP)

(21) Appl. No.: 19/009,440

(22) Filed: Jan. 3, 2025

(30) Foreign Application Priority Data
Mar. 28, 2024 (JP) 2024-052747

(51) Int. Cl. E02F 9/26; B60R 25/04

(52) U.S. Cl. CPC E02F 9/268; B60R 25/04; B60R 2025/0415

(57) ABSTRACT

A mobile body control device that executes abnormality monitoring processing of a mobile body; that recognizes whether or not prescribed setting is completed for a specific electric component mounted on the mobile body; and that sets an abnormality monitoring function disabled state and an abnormality monitoring function enabled state, the abnormality monitoring function disabled state being set to prohibit executing the abnormality monitoring processing when does not recognize that the prescribed setting of the specific electrical component is completed, and the abnormality monitoring function enabled state being set to allow executing the abnormality monitoring processing when recognizes that the prescribed setting of the specific electrical component is completed.

### INCORPORATION BY REFERENCE

The present application claims priority under 35 U.S.C. § 119 to Japanese Patent Application No. 2024-052747 filed on Mar. 28, 2024. The content of the application is incorporated herein by reference in its entirety.

### BACKGROUND OF THE INVENTION

### Field of the Invention

The present invention relates to a mobile body control device, a mobile body control method, and a storage medium.

### Description of the Related Art

For abnormality information devices for construction machines, there has been disclosed a technique of connecting a service tool device and performing mode switching operation so as to perform abnormality detection (failure diagnosis) and abnormality output in a normal mode while prohibiting abnormality detection in a maintenance mode (see, for example, WO 2014/203990 A1).

In the process of manufacturing mobile bodies, an abnormality detection function needs to be disabled to prevent the situation where mobile bodies not in a completed state are detected to be abnormal in the manufacturing process and abnormal output is performed, and then after the mobile bodies are completed, the abnormality detection function needs to be enabled. When the service tool device is connected and the abnormality detection function is switched to be in an enabled mode or a disabled mode as in the conventional technology, man-hours from manufacturing to shipment of the mobile bodies disadvantageously increase due to performing operation for disabling the abnormality detection function and operation for enabling the abnormality detection function.

Accordingly, an object of this application is to switch the abnormality detection function to be disabled and enabled in the process from manufacturing to shipment of a mobile body while restraining increase in man-hours.

In accomplishing the above object, a goal of this application is to achieve improvement in safety of the mobile body. This in turn contributes to the development of sustainable transportation systems by further enhancing the safety of the traffic.

### SUMMARY OF THE INVENTION

A first aspect for achieving the above goal relates to a mobile body control device, including: an abnormality monitoring unit that executes abnormality monitoring processing that monitors presence or absence of abnormality of a mobile body and outputs abnormality notification information when recognizing the abnormality of the mobile body; a specific electrical component state recognizing unit that recognizes whether or not prescribed setting is completed for a specific electric component mounted on the mobile body; and an abnormality monitoring function setting unit that sets an abnormality monitoring function disabled state and an abnormality monitoring function enabled state, the abnormality monitoring function disabled state being set to prohibit the abnormality monitoring unit from executing the abnormality monitoring processing when the specific electrical component state recognizing unit does not recognize that the prescribed setting of the specific electrical component is completed, and the abnormality monitoring function enabled state being set to allow the abnormality monitoring unit to execute the abnormality monitoring processing when the specific electrical component state recognizing unit recognizes that the prescribed setting of the specific electrical component is completed.

In the mobile body control device, the abnormality monitoring function setting unit may be configured to perform switching to the abnormality monitoring function enabled state when the specific electrical component state recognizing unit recognizes that the prescribed setting of the specific electrical component is completed in the abnormality monitoring function disabled state and when the mobile body is switched from a standby state where the mobile body is not operable to an activated state where the mobile body is operable, in accordance with an operation in an operation unit that instructs switching between the activated state and the standby state.

In the mobile body control device, the abnormality monitoring unit may be configured to store abnormality recognition information in a storage unit when recognizing the abnormality of the mobile body, and the abnormality monitoring unit may be configured to store the abnormality recognition information including a prescribed code in the storage unit when recognizing the abnormality of the mobile body within a predetermined time from a time when the abnormality monitoring function disabled state is switched to the abnormality monitoring function enabled state.

In the mobile body control device, the specific electrical component may be configured as an anti-theft device, and the prescribed setting may be configured as registration setting to enable an anti-theft function of the anti-theft device.

In the mobile body control device, the specific electrical component may be configured as an anti-theft device, and the prescribed setting may be configured as registration setting to enable an anti-theft function of the anti-theft device, and the abnormality monitoring function setting unit may be configured to perform switching to the abnormality monitoring function enabled state when the specific electrical component state recognizing unit recognizes that the registration setting of the anti-theft device is completed in the abnormality monitoring function disabled state and when anti-theft authentication is established by an anti-theft function in accordance with the operation in the operation unit and the mobile body is switched from the standby state to the activated state.

A second aspect for achieving the above goal relates to a mobile body control method to be executed by a computer, including: an abnormality monitoring step of executing abnormality monitoring processing that determines presence or absence of abnormality of a mobile body and outputs abnormality notification information when recognizing the abnormality of the mobile body; a specific electrical component state recognizing step of recognizing whether or not prescribed setting is completed for a specific electrical component mounted on the mobile body; and an abnormality monitoring function setting step of setting an abnormality monitoring function disabled state and an abnormality monitoring function enabled state, the abnormality monitoring function disabled state being set to prohibit the abnormality monitoring processing from being executed in the abnormality monitoring step when it is not recognized in the specific electrical component recognizing step that the prescribed setting of the specific electrical component is completed, and the abnormality monitoring function enabled state being set to allow the abnormality monitoring processing to be executed in the abnormality monitoring step when it is recognized in the specific electrical component state recognizing step that the prescribed setting of the specific electrical component is completed.

A third aspect for achieving the above goal relates to a non-transitory computer-readable storage medium storing a program for causing a computer to function as: an abnormality monitoring unit that executes abnormality monitoring processing that determines presence or absence of abnormality of a mobile body and outputs abnormality notification information when recognizing the abnormality of the mobile body; a specific electrical component state recognizing unit that recognizes whether or not prescribed setting is completed for a specific electric component mounted on the mobile body; and an abnormality monitoring function setting unit that sets an abnormality monitoring function disabled state and an abnormality monitoring function enabled state, the abnormality monitoring function disabled state being set to prohibit the abnormality monitoring unit from executing the abnormality monitoring processing when the specific electrical component state recognizing unit does not recognize that the prescribed setting of the specific electrical component is completed, and the abnormality monitoring function enabled state being set to allow the abnormality monitoring unit to execute the abnormality monitoring processing when the specific electrical component state recognizing unit recognizes that the prescribed setting of the specific electrical component is completed.

The mobile body control device, the mobile body control method, and the storage medium make it possible to switch the abnormality detection function to be disabled and enabled in the process from manufacturing to shipment of the mobile body while restraining increase in man-hours.

### BRIEF DESCRIPTION OF THE DRAWINGS

FIG. 1 is a configuration diagram of a mobile body control device;

FIG. 2 is a first flowchart of abnormality monitoring function setting processing;

FIG. 3 is a second flowchart of the abnormality monitoring function setting processing; and

FIG. 4 is a timing chart at the time of switching the abnormality monitoring function from a disabled state to an enabled state when a vehicle is shipped.

### DETAILED DESCRIPTION OF THE INVENTION

### 1. Configuration of Mobile Body Control Device

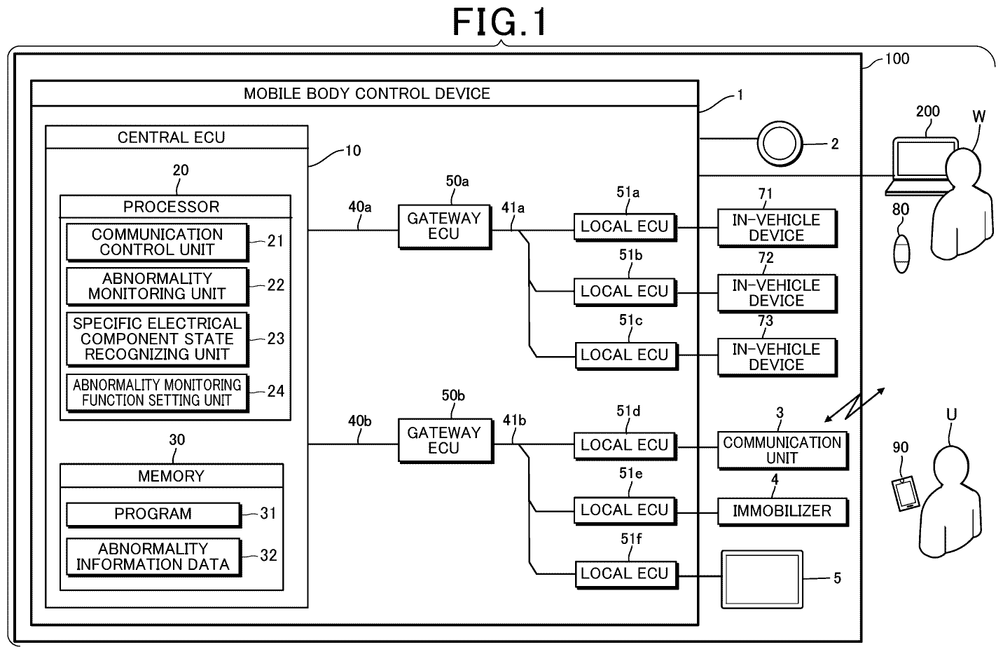

The configuration of a mobile body control device 1 of the present embodiment will be described with reference to FIG. 1. The mobile body control device 1 is mounted on a vehicle 100 to control the operation of the vehicle 100. The vehicle 100 corresponds to the mobile body in the present disclosure. The mobile body in the present disclosure may be other than a vehicle, such as an aircraft or a ship. The vehicle 100 includes a start/stop (SS) switch 2 that instructs activation and deactivation (ignition (IG) on and IG off, power on and power off) of the vehicle 100, a communication unit 3, an immobilizer 4, and a display 5. In response to activation operation (start operation) of the SS switch 2, the vehicle 100 enters an activated state (IG on state) where the vehicle 100 is operable, and in response to deactivation operation (stop operation) of the SS switch, the vehicle 100 enters a standby state (IG off state) where the vehicle 100 is not operable.

The communication unit 3 includes a transmitter and a receiver and performs short-range wireless communication, using specifications such as Bluetooth (registered trademark) and ultra wide band (UWB), with a remote control key 80 of the vehicle 100 and a user terminal 90 used by a user U of the vehicle 100. The user terminal 90 is a device such as a smartphone, a mobile phone, or a tablet terminal.

The immobilizer 4, which is an anti-theft device for the vehicle 100, collates a key ID transmitted from the remote control key 80 with a key ID on the side of the vehicle 100 stored in the memory of the immobilizer 4. When the key IDs match each other, the vehicle 100 is allowed to be activated, and when the key IDs do not match each other, activation of the vehicle 100 is prohibited. A worker W who performs shipping operation of the vehicle 100 connects a service terminal 200 to the mobile body control device 1, and registers a key ID in the immobilizer 4 to enable an anti-theft function of the immobilizer 4. The immobilizer 4 corresponds to the specific electrical component in the present disclosure, and registration setting (anti-theft registration) for registering the key ID in the immobilizer 4 to enable the anti-theft function corresponds to the prescribed setting in the present disclosure.

The mobile body control device 1 includes a central electronic control unit (ECU) 10, gateway ECUs 50a and 50b, and local ECUs 51a to 51f. Each ECUs includes a processor. The central ECU 10 is connected to the gateway ECU 50a through a communication line 40a and to the gateway ECU 50b through a communication line 40b.

The gateway ECU 50a is connected to the plurality of local ECUs 51a to 51c through a communication line 41a and the gateway ECU 50b is connected to the plurality of local ECUs 51d1 to 51f through a communication line 41b. The local ECUs 51a to 51c control the operation of in-vehicle devices 71 to 73 included in the vehicle 100. Examples of the in-vehicle devices 71 to 73 include a drive source such as an engine and an electric motor, a driving operation unit such as a steering wheel, a brake pedal, and an accelerator pedal, a lamp body such as headlights, an auxiliary machine such as wipers, electric equipment such as power sliding doors and power windows, and an air conditioner. The local ECU 51d controls the operation of the communication unit 3, the local ECU 51e controls the operation of the immobilizer 4, and the local ECU 51f controls the operation of the display 5.

Hereinafter, the gateway ECU 50a and the gateway ECU 50b are collectively referred to as the gateway ECUs 50, and the local ECUs 51a to 51f are collectively referred to as the local ECUs 51. Devices connected to the local ECUs 51 are collectively referred to as in-vehicle devices. The central ECU 10, the gateway ECUs 50, and the local ECUs 51 are control units each including a processor, a memory, an interface circuit, and the like.

The local ECUs 51 connected to the gateway ECUs 50 are grouped according to the function and arrangement location of the in-vehicle devices connected to the local ECUs 51. FIG. 1 illustrates two gateways ECUs 50a and 50b, though three or more gateway ECUs 50 may be provided. The local ECUs 51 may be connected to two or more in-vehicle devices.

The central ECU 10 communicates with the local ECUS 51 to monitor the presence or absence of abnormality in the in-vehicle devices connected to the local ECUs 51, and also includes an abnormality monitoring function to monitor the presence or absence of abnormality in the central ECU 10, the gateway ECUs 50, and the local ECUs 51. The central ECU 10 disables the abnormality monitoring function in the manufacturing process of the vehicle 100 at a factory so as to prevent output of unnecessary abnormality notification in the manufacturing process, and executes processing to enable the abnormality monitoring function at the time of shipping a completed vehicle 100. The processing of switching the abnormality monitoring function from a disabled state to an enabled state is described below.

The central ECU 10 includes devices such as a processor 20 and a memory 30, and the memory 30 stores a program 31 for controlling the mobile body control device 1. The memory 30 also stores abnormality information data 32 in which abnormality information about abnormality detected in the central ECU 10, the gateway ECUs 50, the local ECUs 51, and the in-vehicle devices connected to the local ECUs 51 are recorded. The processor 20 corresponds to the computer in the present disclosure, and the memory 30 corresponds to the storage unit in the present disclosure. The processor 20 reads and executes the program 31 to function as a communication control unit 21, an abnormality monitoring unit 22, a specific electrical component state recognizing unit 23, and an abnormality monitoring function setting unit 24.

The processing executed by the abnormality monitoring unit 22 corresponds to the abnormality monitoring step in the mobile body control method of the present disclosure, and the processing executed by the specific electrical component state recognizing unit 23 corresponds to the specific electrical component recognizing step in the mobile body control method of the present disclosure. The processing executed by the abnormality monitoring function setting unit 24 corresponds to the abnormality monitoring function setting step in the mobile body control method of the present disclosure.

The communication control unit 21 controls communication of the communication unit 3 with the remote control key 80 and the user terminal 90. The abnormality monitoring unit 22 executes abnormality monitoring processing that monitors the presence or absence of abnormality of the vehicle 100 and outputs abnormality notification information when recognizing the abnormality of the vehicle 100. The abnormality monitoring unit 22 monitors the presence or absence of abnormality of monitoring targets, including the in-vehicle devices connected to the local ECUs 51, the central ECU 10, the gateway ECUs 50, and the local ECUs 51 in the abnormality monitoring processing. When any abnormality is recognized, the abnormality monitoring unit 22 displays on the display 5 abnormality notification including a diagnostic trouble code (DTC) indicating an abnormal system, an abnormality occurrence location, and an abnormality state, and records abnormality occurrence information including the DTC in the abnormality information data 32.

The specific electrical component state recognizing unit 23 recognizes whether or not anti-theft registration in the immobilizer 4 is completed. The abnormality monitoring function setting unit 24 switches an abnormality monitoring function disabled state set to prohibit the abnormality monitoring unit 22 from executing the abnormality monitoring processing and an abnormality monitoring function enabled state set to allow the abnormality monitoring unit 22 to execute the abnormality monitoring processing, depending on a switching condition 1 and a switching condition 2 below.

The switching condition 1: the abnormality monitoring function setting unit 24 sets the abnormality monitoring function disabled state when the specific electrical component state recognizing unit 23 does not recognize that the anti-theft registration in the immobilizer 4 is completed.

The switching condition 2: the abnormality monitoring function setting unit 24 sets the abnormality monitoring function enabled state when all conditions (1) to (3) below are satisfied.
(1) the specific electrical component state recognizing unit 23 recognizes that the anti-theft registration in the immobilizer 4 is completed.
(2) the immobilizer 4 executes anti-theft authentication using the key ID of the remote control key 80, and authentication is OK.
(3) the vehicle 100 transitions from an IG off state to an IG on state in response to start operation of the SS switch 2.

Note that the abnormality monitoring function enabled state may be set when the condition (1) is established, the conditions (1) and (2) are established, or the conditions (1) and (3) are established, instead of when all the conditions (1) to (3) are determined.

### 2. Abnormality Monitoring Function Setting Processing

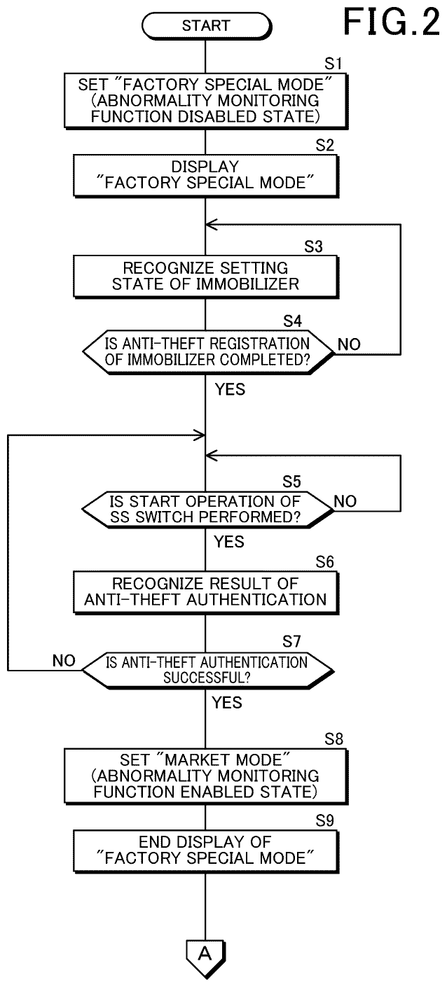

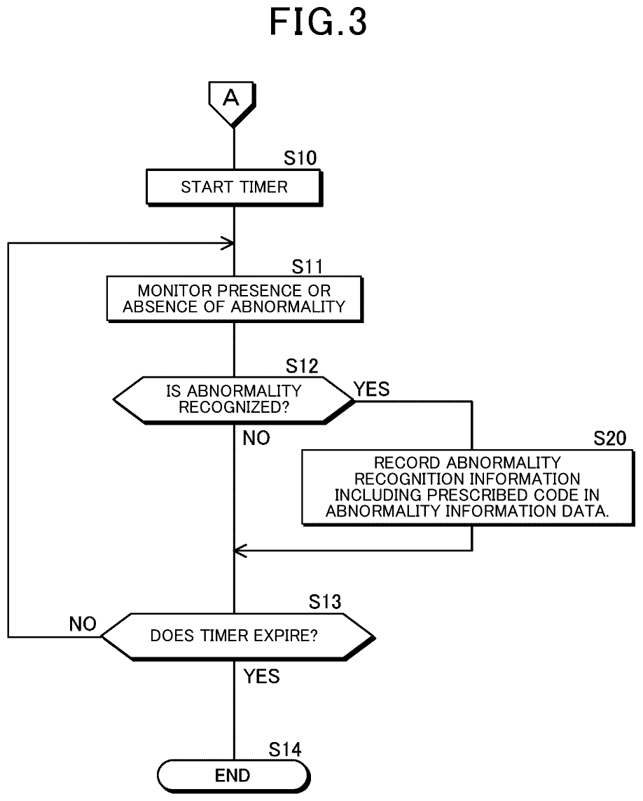

According to the flowcharts shown in FIGS. 2 and 3, the procedures of the abnormality monitoring function setting processing executed by the mobile body control device 1 are described. The mobile body control device 1 executes the processing based on the flowcharts shown in 2 to 3 during the process from manufacturing at factory to shipment to the market of the vehicle 100. The mobile body control device 1 also executes the processing based on the flowcharts shown in FIGS. 2 to 3 when the anti-theft registration in the immobilizer 4 is reset during such occasions as maintenance of the vehicle 100.

Steps S1 to S4 in FIG. 2 are processing steps corresponding to the process of manufacturing the vehicle 100. Since the anti-theft registration in the immobilizer 4 is not yet performed in the manufacturing process, the abnormality monitoring function setting unit 24 sets an operating mode of the vehicle 100 to “factory special mode”, which corresponds to the abnormality monitoring function disabled state, according to the above switching condition 1. In next step S2, the abnormality monitoring function setting unit 24 displays on the display 5 a screen that notifies that the “factory special mode” is set.

In next step, S3, the specific electrical component state recognizing unit 23 recognizes the setting state of the immobilizer 4. In next step S4, the specific electrical component state recognizing unit 23 advances the processing to step S5 when the specific electrical component state recognizing unit 23 recognizes that the anti-theft registration in the immobilizer 4 is completed, and advances the processing to step S3 when the specific electrical component state recognizing unit 23 does not recognize the completion of the anti-theft registration.

In step S5, the abnormality monitoring function setting unit 24 advances the processing to step S6 when the start operation of the SS switch 2 is performed. In response to the start operation of the SS switch 2, the immobilizer 4 executes anti-theft authentication with the key ID. In next step S6, the abnormality monitoring function setting unit 24 recognizes the result of the anti-theft authentication through communicating with the immobilizer 4. In next step S7, the abnormality monitoring function setting unit 24 advances the processing to step S8 when the anti-theft authentication is successful, and advances the processing to step S8 when the anti-theft authentication is not successful.

In step S8, the abnormality monitoring function setting unit 24 switches the control mode of the vehicle 100 to “market mode” (corresponding to the abnormality monitoring function enabled state). In next step S9, the abnormality monitoring function setting unit 24 ends display of the notification screen of the “factory special mode” on the display 5. In next step S10 in FIG. 3, the abnormality monitoring unit 22 starts a timer to manage an elapsed time from the time when the “factory special mode” is switched to the “market mode”. The set time of the timer is a few hours, for example.

In next step S11, the abnormality monitoring unit 22 monitors the presence or absence of abnormality of the monitoring targets as described above. In next step S12, the abnormality monitoring unit 22 advances the processing to step S20 when the abnormality of the monitoring targets is recognized, and advances the processing to step S13 when the abnormality of the monitored targets is not recognized.

In step S20, the abnormality monitoring unit 22 records abnormality recognition information including a prescribed code in the abnormality information data 32. The prescribed code is to indicate that the abnormality of the monitoring targets has occurred immediately after the “factory special mode” is switched to the “market mode”. With the prescribed code included in the abnormality recognition information, the abnormality recognition information regarding the abnormality, which is caused by such operation as removal of the in-vehicle devices, can be recognized in a manner distinguishable from the abnormality recognition information regarding normal abnormality, when final confirmation of the vehicle 100 is performed before shipment.

In step S13, the abnormality monitoring unit 22 advances the processing to step S11 when the timer does not expire, and advances the processing to S14 to end the abnormality monitoring function setting processing when the timer expires.

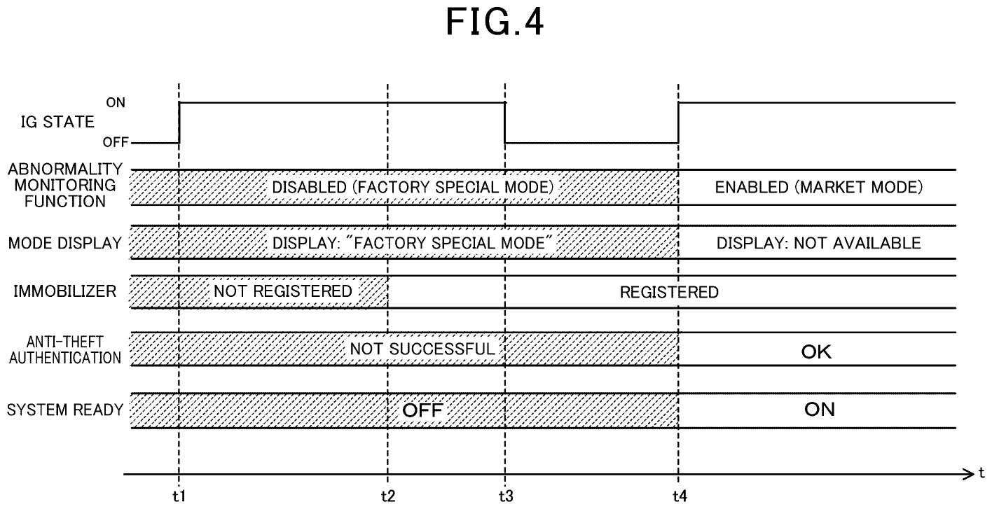

FIG. 4 is a timing chart showing the IG on and off states, the abnormality monitoring function disabled and enabled, control mode display, the state of anti-theft registration in the immobilizer 4, the result of anti-theft authentication by the immobilizer 4, and on and off switching of system READY in the control system of the vehicle 100, along a common time axis t.

In FIG. 4, at t1 in the manufacturing process of the vehicle 100, the worker W performs start operation of the SS switch 2 to set the vehicle 100 in the IG on state. Since the anti-theft registration in the immobilizer 4 is not yet performed at t1, the vehicle 100 is in the factory special mode that is the abnormality monitoring function disabled state, and the notification screen of “factory special mode” is displayed on the display 5.

At t2, the worker W operates the service terminal 200 connected to the mobile body control device 1 and performs anti-theft registration in the immobilizer 4 (registration of the remote control key 80 in the immobilizer 4). The worker W performs stop operation of the SS switch 2 to set the IG off state at t3, and performs start operation of the SS switch 2 at t4. In response to the start operation of the SS switch 2, the immobilizer 4 performs anti-theft authentication, and when the anti-theft authentication is OK, the immobilizer 4 authorizes IG on, and the system READY of the control system of the vehicle 100 is switched from off to on.

As shown in FIG. 4, the abnormality monitoring function disabled state is switched to the abnormality monitoring function enabled state when the worker W performs normal operation at the time of shipping the vehicle 100, the normal operation including anti-theft registration in the immobilizer 4, start operation of the SS switch 2, and confirming activation of the vehicle 100 when the authentication of the remote control key 80 is OK. Therefore, in the process from manufacturing to shipment of the vehicle 100, there is no need to perform a separate operation to disable and enable the abnormality monitoring function, which makes it possible to switch the abnormality monitoring function to be disabled and enabled while restraining the increase in man-hours.

### 3. Other Embodiments

In the above embodiment, the immobilizer 4 is illustrated as the specific electrical component in the present disclosure, though the specific electrical component may be another anti-theft device or may be another type of specific electrical component other than the anti-theft device. Examples of the another anti-theft device includes a shift lock device, a steering lock device, and the like, and examples of the another type of specific electrical component include a user identification device that identifies the user U by identification processing such as facial recognition, and the like. The setting to enable the functions of these devices correspond to the prescribed setting in the present disclosure.

In the above embodiment, in the processing in steps S10 to S13 and step S20 in FIG. 3, the abnormality monitoring unit 22 records in the abnormality information data 32 the abnormality recognition information including a prescribed code for the abnormality that is recognized within a prescribed time from the time when the abnormality monitoring function disabled state is switched to the abnormality monitoring function enabled state. Another embodiment may have a configuration in which the processing of steps S10 to S13 and step S20 in FIG. 3 are omitted.

In the above embodiment, as shown in FIG. 4, the IG on and IG off states are illustrated as the activated state and the standby state in the present disclosure. However, in an electric vehicle without IG function, the activated state and the standby state correspond to the power on and power off states.

FIG. 1 is a schematic view in which the configuration of the mobile body control device 1 is categorized and shown according to main processing contents for easy understanding of the present invention, and therefore, the configuration of the mobile body control device 1 may be configured according to other categories. The processing of each component member may be executed by a single hardware unit or may be executed by a plurality of hardware units. The processing by each component member shown in FIGS. 2 to 3 may be executed by a single program or may be executed by a plurality of programs.

### 4. Configurations Supported by Above Embodiment

The embodiment disclosed is a specific example of the following configurations.

(Configuration 1) A mobile body control device, including: an abnormality monitoring unit that executes abnormality monitoring processing that monitors presence or absence of abnormality of a mobile body and outputs abnormality notification information when recognizing the abnormality of the mobile body; a specific electrical component state recognizing unit that recognizes whether or not prescribed setting is completed for a specific electric component mounted on the mobile body; and an abnormality monitoring function setting unit that sets an abnormality monitoring function disabled state and an abnormality monitoring function enabled state, the abnormality monitoring function disabled state being set to prohibit the abnormality monitoring unit from executing the abnormality monitoring processing when the specific electrical component state recognizing unit does not recognize that the prescribed setting of the specific electrical component is completed, and the abnormality monitoring function enabled state being set to allow the abnormality monitoring unit to execute the abnormality monitoring processing when the specific electrical component state recognizing unit recognizes that the prescribed setting of the specific electrical component is completed.

In the mobile body control device in configuration 1, the abnormality monitoring function disabled state and the abnormality monitoring function enabled state are switched according to the prescribed setting of the specific electrical component, which is a normal operation performed in the process from manufacturing to shipment of the mobile body. This makes it possible to switch the abnormality detection function to be disabled and enabled in the process from manufacturing to shipment of the mobile body while restraining increase in man-hours.

(Configuration 2) The mobile body control device according to configuration 1, in which the abnormality monitoring function setting unit performs switching to the abnormality monitoring function enabled state when the specific electrical component state recognizing unit recognizes that the prescribed setting of the specific electrical component is completed in the abnormality monitoring function disabled state and when the mobile body is switched from a standby state where the mobile body is not operable to an activated state where the mobile body is operable, in accordance with operation in an operation unit that instructs switching between the activated state and the standby state.

The mobile body control device in configuration 2 makes it possible to set to the abnormality monitoring function enabled state by confirming that the transition from the standby state to the activated state by the operating unit is normally performed.

(Configuration 3) The mobile body control device according to configuration 1 or 2, in which the abnormality monitoring unit stores abnormality recognition information in a storage unit when recognizing the abnormality of the mobile body, and the abnormality monitoring unit stores the abnormality recognition information including a prescribed code in the storage unit when recognizing the abnormality of the mobile body within a predetermined time from a time when the abnormality monitoring function disabled state is switched to the abnormality monitoring function enabled state.

According to the mobile body control device in configuration 3, abnormality confirmation information regarding the abnormality attributed to such causes as removal of an electrical component at a final check of the mobile body, which is carried out immediately after switching from the abnormality monitoring function disabled state to the abnormality monitoring function enabled state, can be managed in a manner distinguishable from abnormality confirmation information regarding other abnormality, with the presence or absence of the prescribed code.

(Configuration 4) The mobile body control device according to any one of configurations 1 to 3, in which the specific electrical component is an anti-theft device, and the prescribed setting is registration setting to enable an anti-theft function of the anti-theft device.

The mobile body control device in configuration 4 makes it possible to switch from the abnormality monitoring function disabled state to the abnormality monitoring function enabled state by performing registration setting of the anti-theft device.

(Configuration 5) The mobile body control device according to configuration 2, in which the specific electrical component is an anti-theft device, and the prescribed setting is registration setting to enable an anti-theft function of the anti-theft device, and the abnormality monitoring function setting unit performs switching to the abnormality monitoring function enabled state when the specific electrical component state recognizing unit recognizes that the registration setting of the anti-theft device is completed in the abnormality monitoring function disabled state and when anti-theft authentication is established by an anti-theft function in accordance with the operation in the operation unit and the mobile body is switched from the standby state to the activated state.

The mobile body control device in configuration 5 makes it possible to switch from the abnormality monitoring function disabled state to the abnormality monitoring function enabled state by confirming that the anti-theft function of the anti-theft device normally operates.

(Configuration 6) A mobile body control method to be executed by a computer, including: an abnormality monitoring step of executing abnormality monitoring processing that determines presence or absence of abnormality of a mobile body and outputs abnormality notification information when recognizing the abnormality of the mobile body; a specific electrical component state recognizing step of recognizing whether or not prescribed setting is completed for a specific electrical component mounted on the mobile body; and an abnormality monitoring function setting step of setting an abnormality monitoring function disabled state and an abnormality monitoring function enabled state, the abnormality monitoring function disabled state being set to prohibit the abnormality monitoring processing from being executed in the abnormality monitoring step when it is not recognized in the specific electrical component recognizing step that the prescribed setting of the specific electrical component is completed, and the abnormality monitoring function enabled state being set to allow the abnormality monitoring processing to be executed in the abnormality monitoring step when it is recognized in the specific electrical component state recognizing step that the prescribed setting of the specific electrical component is completed.

When the mobile body control method of configuration 6 is executed by a computer, the operational effects similar to those of the mobile body control device of configuration 1 can be achieved.

(Configuration 7) A non-transitory computer-readable storage medium storing a program for causing a computer to function as: an abnormality monitoring unit that executes abnormality monitoring processing that determines presence or absence of abnormality of a mobile body and outputs abnormality notification information when recognizing the abnormality of the mobile body; a specific electrical component state recognizing unit that recognizes whether or not prescribed setting is completed for a specific electric component mounted on the mobile body; and an abnormality monitoring function setting unit that sets an abnormality monitoring function disabled state and an abnormality monitoring function enabled state, the abnormality monitoring function disabled state being set to prohibit the abnormality monitoring unit from executing the abnormality monitoring processing when the specific electrical component state recognizing unit does not recognize that the prescribed setting of the specific electrical component is completed, and the abnormality monitoring function enabled state being set to allow the abnormality monitoring unit to execute the abnormality monitoring processing when the specific electrical component state recognizing unit recognizes that the prescribed setting of the specific electrical component is completed.

When the program of configuration 7 is executed by a computer, the configuration of the mobile body control device of configuration 1 can be implemented.

### REFERENCE SIGNS LIST

1 . . . Mobile body control device, 2 . . . SS switch, 3 . . . Communication unit, 4 . . . Immobilizer, 5 . . . Display, 10 . . . Central ECU, 20 . . . Processor, 21 . . . Communication control unit, 22 . . . Abnormality monitoring unit, 23 . . . Specific electrical component state recognizing unit, 24 . . . Abnormality monitoring function setting unit, 30 . . . Memory, 31 . . . Program, 32 . . . Abnormality information data, 50 (50a, 50b) . . . Gateway ECU, 51 (51a to 51f) . . . Local ECU, 71 to 73 . . . In-vehicle device, 80 . . . Remote control key, 90 . . . User terminal, 100 . . . Vehicle (mobile body), U . . . User, W . . . Worker.

1. A mobile body control device, comprising:
an abnormality monitoring unit that executes abnormality monitoring processing that monitors presence or absence of abnormality of a mobile body and outputs abnormality notification information when recognizing the abnormality of the mobile body;
a specific electrical component state recognizing unit that recognizes whether or not prescribed setting is completed for a specific electric component mounted on the mobile body; and
an abnormality monitoring function setting unit that sets an abnormality monitoring function disabled state and an abnormality monitoring function enabled state, the abnormality monitoring function disabled state being set to prohibit the abnormality monitoring unit from executing the abnormality monitoring processing when the specific electrical component state recognizing unit does not recognize that the prescribed setting of the specific electrical component is completed, and the abnormality monitoring function enabled state being set to allow the abnormality monitoring unit to execute the abnormality monitoring processing when the specific electrical component state recognizing unit recognizes that the prescribed setting of the specific electrical component is completed.

2. The mobile body control device according to claim 1, wherein
the abnormality monitoring function setting unit switches to the abnormality monitoring function enabled state when the specific electrical component state recognizing unit recognizes that the prescribed setting of the specific electrical component is completed in the abnormality monitoring function disabled state and when the mobile body is switched from a standby state where the mobile body is not operable to an activated state where the mobile body is operable in accordance with operation in an operation unit that instructs switching between the activated state and the standby state.

3. The mobile body control device according to claim 1, wherein
the abnormality monitoring unit stores abnormality recognition information in a storage unit when recognizing the abnormality of the mobile body, and
the abnormality monitoring unit stores the abnormality recognition information including a prescribed code in the storage unit when recognizing the abnormality of the mobile body within a predetermined time from a time when the abnormality monitoring function disabled state is switched to the abnormality monitoring function enabled state.

4. The mobile body control device according to claim 1, wherein
the specific electrical component is an anti-theft device, and the prescribed setting is registration setting to enable an anti-theft function of the anti-theft device.

5. The mobile body control device according to claim 2, wherein
the specific electrical component is an anti-theft device, and the prescribed setting is registration setting to enable an anti-theft function of the anti-theft device, and
the abnormality monitoring function setting unit performs switching to the abnormality monitoring function enabled state when the specific electrical component state recognizing unit recognizes that the registration setting of the anti-theft device is completed in the abnormality monitoring function disabled state and when anti-theft authentication is established by an anti-theft function in accordance with the operation in the operation unit and the mobile body is switched from the standby state to the activated state.

6. A mobile body control method to be executed by a computer, comprising:
an abnormality monitoring step of executing abnormality monitoring processing that determines presence or absence of abnormality of a mobile body and outputs abnormality notification information when recognizing the abnormality of the mobile body;
a specific electrical component state recognizing step of recognizing whether or not prescribed setting is completed for a specific electrical component mounted on the mobile body; and
an abnormality monitoring function setting step of setting an abnormality monitoring function disabled state and an abnormality monitoring function enabled state, the abnormality monitoring function disabled state being set to prohibit the abnormality monitoring processing from being executed in the abnormality monitoring step when it is not recognized in the specific electrical component recognizing step that the prescribed setting of the specific electrical component is completed, and the abnormality monitoring function enabled state being set to allow the abnormality monitoring processing to be executed in the abnormality monitoring step when it is recognized in the specific electrical component state recognizing step that the prescribed setting of the specific electrical component is completed.

7. A non-transitory computer-readable storage medium storing a program for causing a computer to function as:
an abnormality monitoring unit that executes abnormality monitoring processing that determines presence or absence of abnormality of a mobile body and outputs abnormality notification information when recognizing the abnormality of the mobile body;
a specific electrical component state recognizing unit that recognizes whether or not prescribed setting is completed for a specific electric component mounted on the mobile body; and
an abnormality monitoring function setting unit that sets an abnormality monitoring function disabled state and an abnormality monitoring function enabled state, the abnormality monitoring function disabled state being set to prohibit the abnormality monitoring unit from executing the abnormality monitoring processing when the specific electrical component state recognizing unit does not recognize that the prescribed setting of the specific electrical component is completed, and the abnormality monitoring function enabled state being set to allow the abnormality monitoring unit to execute the abnormality monitoring processing when the specific electrical component state recognizing unit recognizes that the prescribed setting of the specific electrical component is completed.
